(19) United States
(12) Patent Application Publication
(10) Pub. No.: US 2015/0295668 A1
(43) Pub. Date: Oct. 15, 2015

(54) VISUAL RADIO MARKETING SYSTEM AND METHOD

(71) Applicant: NICOLAS CLIFTON PLACIDE, Miami, FL (US)

(72) Inventor: NICOLAS CLIFTON PLACIDE, Miami, FL (US)

(21) Appl. No.: 14/252,532

(22) Filed: Apr. 14, 2014

(51) Int. Cl. H04H 20/95; G06Q 30/02; G06F 17/30; H04H 40/27; H04H 20/53; H04H 20/74; G06F 3/16; G10L 21/10

(52) U.S. Cl. CPC H04H 20/95; G06F 3/162; G06Q 30/0267; G10L 21/10; H04H 40/27; H04H 20/53; H04H 20/74; G06F 17/30775; H04H 2201/19; H04H 2201/13; H04H 2201/30

(57) ABSTRACT

A visual radio marketing system and method d converts sound from a radio broadcast into an image. The image displays for a user and is associated with the radio broadcast. The image can be used by both the user and an advertiser to enhance marketing and consumption of a product or service advertised on a radio broadcast. The radio broadcast transmits a sound, which is captured by a microphone. Ari algorithm on the computer converts the sound into a visual waveform. A processing unit queries a data storage unit for a prerecorded visual waveform that correlates to the visual waveform. The prerecorded visual waveform is converted to an image through a conversion unit. A streaming unit streams the images, image links, and image data to the computer for display, A positioning system identifies the location of the user. The user interactively makes requests and submissions to the radio broadcast.

### BACKGROUND

The following background information may present examples of specific aspects of the prior art (e.g., without limitation, approaches, facts, or common wisdom) that, while expected to be helpful to further educate the reader as o additional aspects of the prior art, is to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

The present invention is directed to a visual radio marketing system and method that converts the sound from a radio broadcast into an image. The image can be utilized by a user to interact with a radio broadcast for enhancing consumption or knowledge of a product or service.

Typically, radio broadcasting is a one-way wireless transmission over radio waves intended to reach a wide audience. The radio stations can be linked in radio networks Co broadcast a common radio format, either in broadcast syndication or simulcast. Audio broadcasting also can be done through cable radio, local wire television networks, satellite radio, and internet radio via streaming media on the Internet.

It is known that before the advent of broadcast television, broadcast radio controlled roughly 90% of advertising dollars. However, since, up to now, no visual element, no interaction, and no reliable means of tracking ad campaigns results were available to standard AM/FM or HD and satellite radio broadcasts. This is in spite of the fact that broadcast radio still reaches over 243 million Americans every week. Typically, advertisers prefer mediums where they can track marketing expenditures more easily.

Often, the radio broadcast audience has little control over the radio broadcast. The audience cannot inquire further into the product or service offered by the advertisement. If the audience misses a message during the broadcast, it is difficult to return to the radio broadcast. The one-way direction of the radio broadcast leaves little room for interactivity.

Typically, an advertiser on a radio broadcast has difficulty assessing the effectiveness of the advertisements. The size, type, and reach of the audience is more difficult to quantify in radio than other forms of media. For example, the advertiser does not always know what the audience is tuning in to and what the audience is merely hearing, but not digesting from the radio broadcast.

For the foregoing reasons, there is a virtual radio marketing system and method that converts snippets of the radio broadcast into an image that correlates to the sound. The user can then interact with the radio broadcast through the image.

Radio broadcasts and interactive media have been utilized in the past; yet none with the present radio broadcast interactive functions and positioning systems of the present invention. See U.S. Pat. Nos. 5,991,737; 6,975,835; and 20040166798.

For the foregoing reasons, there is an interactive radio broadcast system and method that converts the sound from a radio broadcast into an image for enhancing interactivity with an audience.

### SUMMARY

The present invention is directed to a visual radio marketing system and method that converts the sound from a radio broadcast into an image. The image can be utilized by a user to interact with a radio broadcast for enhancing consumption or knowledge of a product or service. An advertiser benefits from the interaction by enhance marketing and understanding the user better. In one embodiment, the capacity of the system to generate an image provides interactive functionality to a broadcast radio station. The image adds a visual elements that makes the radio broadcast more appealing to users while providing advertisers with access to real-time data and other opportunities to better market their products.

The system is a composition of various components that work together to form a synergy for creating an interactive radio experience for the user and the advertiser. The system comprises a positioning system, a microphone, a computer, a processing unit, a data storage unit, an audio recording unit, a waveform to image conversion unit, and a streaming unit.

In some embodiments, the system operates by capturing sound waves from the radio broadcast. A duration of the sound from the broadcast radio station is captured and stored in an audio recording unit. The subsequently formed image is based on this duration of sound The user requests the time and duration of the sound to be captured from the radio broadcast. The captured sound is converted into a visual waveform. The visual waveform may include a standard sine or cosine wave known in the art to represent sound wave propagation. The visual waveform is representative of the image.

In some embodiments, the user captures a duration of the sound from the radio broadcast. The user controls the capture of sound from the radio broadcast through a microphone on a computer. The computer is configured to regulate aspects of the sound, the image, and all pertinent data.

Once the sound is captured by the microphone, the computer utilizes an algorithm to convert the captured sound into the visual waveform representation. The computer uploads the visual waveform representation into a processing unit. The computer may also upload additional data that is pertinent to the sound into the processing unit, including, the time of sound capture, and the location of the computer during the request.

Upon reception of the visual waveform, the processing unit queries a data storage unit for a prerecorded visual waveform that correlates to the visual waveform from captured sound. The prerecorded visual waveform is based on audio recordings in an audio recording unit. The data storage unit returns a dataset of the prerecorded visual waveform that includes the image, links to images, and image related data. Using the response from the processing unit, the computer connects to the proper channel of a streaming unit in order to stream the appropriate content to the user. In this manner, a full interaction with the user is possible.

A waveform to image conversion unit converts the prerecorded visual waveform into the image. The waveform to image conversion unit utilizes a second algorithm that extracts portions of the images that match a corresponding time stamp and desired length of the recording and compares them to the visual waveform received from the computer until a match is found. The image may include a picture or a video that is associated with the captured sound from the radio broadcast.

In some embodiments, a positioning system, such as a global positioning system (GPS), provides the location of the user at the time and place of the request. The advertiser benefits from real time data offered through the positioning system, such as the location of the computer at the time of the sound request. In this manner, the advertiser identifies the location of the user at the time of the request, and learns the behavior and patterns of the user for enhancing the marketing effort on the broadcast radio station.

One objective of the present invention is to add interactivity between a user and a radio broadcast.

Another objective is to view content associated with a broadcast radio show in real-time.

Another objective is to enable interaction with content of broadcast radio shows, including commercials.

Another objective is to give radio station operators the ability to see in real-time the approximate number of users tuned in o their broadcast.

Another objective is to enable the advertiser to easily assess the performance of specific radio stations and/or programs.

Another objective is to enable the advertiser to target high traffic radio stations.

Another objective is to enable the user to rate shows and radio stations.

Another objective is to provide the user with the ability to save shows of interest.

Another objective is to enable the user to save specific advertisements of interest.

Another objective is to provide instant coupons, distance, and directions to a place of business of advertiser.

Another objective is to enable the advertiser to directly sell products featured during the broadcast to the user.

### DRAWINGS

These and other features, aspects, and advantages of the present invention will become better understood with regard to the following description, appended claims, and drawings where:

FIGS. 1A and 1B are block diagrams of an exemplary billboard marketing system;

FIG. 2 is a flowchart diagram of an exemplary method for billboard marketing;

FIG. 3 is a flowchart diagrams of an exemplary method for registering a new broadcast radio station;

FIG. 4 is a flowchart diagrams of an exemplary method for registering a new advertiser;

FIG. 5 is a flowchart diagram of an exemplary station identification module;

FIG. 6 is a flowchart diagram of an exemplary image comparison module;

FIG. 7 is a flowchart diagrams of an exemplary method for obtaining an image waveform from a radio station;

FIG. 8 is a flowchart diagram of an exemplary station details module; and

FIG. 9 is a block diagram depicting an exemplary client/server system which may be used by an exemplary web-enabled/networked embodiment of the present invention.

### DESCRIPTION

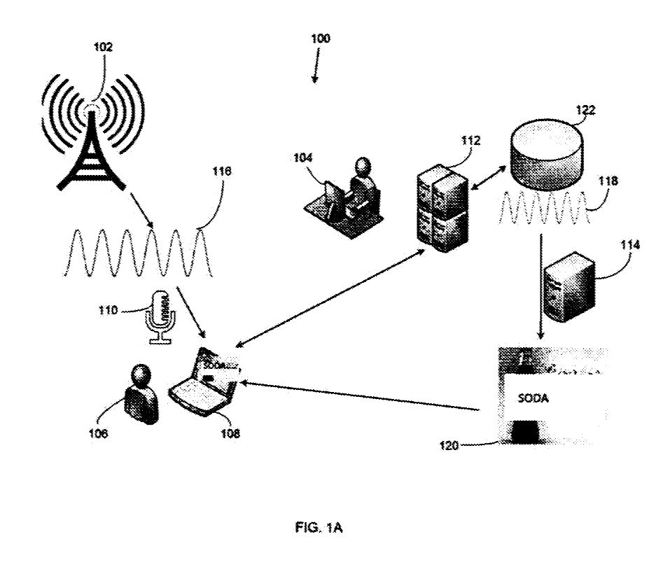

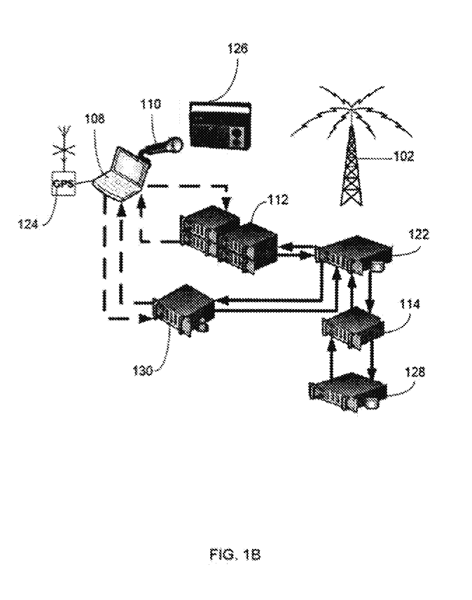

FIGS. 1A-9 illustrate a visual radio marketing system 100, and a visual radio marketing method 200. The present invention is directed to a visual radio marketing system 100 that converts the sound from a radio broadcast into an image 120. The subsequently formed image 120 may be utilized by a user 106 and an advertiser 104 to enhance marketing and consumption of a product or service. For example, by creating a more visual picture of the listening habits of the user 106, and the characteristics of a product or service advertised on the radio broadcast.

In one embodiment, the capacity of the system 100 to generate an image 120 provides interactivity to a radio broadcast. The interactive radio broadcast adds a visual elements that makes broadcast radio more appealing to users 106 while providing advertisers 104 with access to real-time data and other behavioral observations of the user 106 to better market the product or service.

FIGS. 1A and 1B reference the visual radio marketing system 100 for converting the sound of a radio broadcast into an image 120. The system 100 comprises a positioning system 124, a microphone 110, a computer 108, a processing unit 112, a data storage unit 122, an audio recording unit 128, a waveform to image conversion unit 114, and a streaming unit 130. These components work together to form a synergy for creating an interactive radio experience for the user 106 and the advertiser 104.

In some embodiments, the system 100 captures sound waves from the radio broadcast, and converts the sound waves into a visual waveform 116 that correlates to a prerecorded visual waveform 118. The prerecorded visual waveform 118 may then be converted into an image 120 that associates with the radio broadcast.

In one embodiment, a radio broadcast transmits programming in the form of music, advertisements, talk shows, and the like. The broadcast radio station 102 emits electromagnetic radiation in the form of radio waves. A standard radio receiver 126 is tuned to catch the appropriate frequency. The radio waves transmit to the radio receiver 126, which may include, AM, FM, or HD. The radio waves create a vibration that propagates through the air to form the sound.

The system 100 comprises a computer 108 that the user 106 utilizes to process sound, and display the resultant image 120 and image related data. In some embodiments, the user 106 captures a predetermined duration of the sound from the radio broadcast. The user 106 may control the capture of sound through a computer 108. In one embodiment, the computer 108 comprises a microphone 110 that captures the sound from the radio broadcast. The sound from the broadcast radio station 102 can be captured and stored in an audio recording unit 128 for subsequent retrieval and conversion into the image 120. Additionally, the audio recording unit 128 can record and store prerecorded sound that serves as a reference point for the system 100.

The computer 108 utilizes an algorithm to convert the captured sound into a visual waveform 116 representation. The visual waveform 116 may include a standard sine or cosine wave known in the art to represent sound wave propagation. The visual waveform 116 is representative of the image 120. The computer 108 uploads the visual waveform 116 representation into a processing unit 112. The computer 108 may also upload additional data that is pertinent to the sound into the processing unit 112, including, the time of sound capture, and the location of the computer 108 during the request.

Upon reception of the visual waveform 116 generated by the algorithm, the processing unit 112 queries a data storage unit 122 for a prerecorded visual waveform 118 that correlates to the visual waveform 116 of the captured sound. The data storage unit 122 returns a dataset of the prerecorded visual waveform 118 that may include an image 120, links to images, image related data, and the sound in the audio recording unit 128. Using the response from the processing unit 112, the computer 108 connects to the proper channel of a streaming unit 130 in order stream the appropriate content to the user 106. In this manner, a full interaction with the user 106 is possible.

A waveform to image conversion unit 114 converts the prerecorded visual waveform 118 into the image 120. The waveform to image conversion unit 114 utilizes a second algorithm that extracts portions of the images 120 that match a corresponding time stamp and desired length of the recording and compares them to the visual waveform 116 received from the computer 108 until a match is found. The image 120 may include a picture or a video that is associated with the captured sound from the radio broadcast.

In yet another embodiment, the computer 108 may include a positioning system 124 for enabling an advertiser 104 to identify the exact location of the user 106. The positioning system 124 may include a global positioning system (GPS). However in other embodiments, the positioning system 124 may include, without limitation, a Wi-Fi tower system, a radio frequency locating system, a laser system, and a sound positioning system. In either case, the location of the user 106, through the computer 108 is determined in real time, and the advertiser 104 can act accordingly based on the location and interaction activity.

In one embodiment, the positioning system 124 enables the advertiser 104 to better understand the performance of the radio broadcast by tracking the number of users 106 that listen to the radio broadcast station 102, along with the interactions between the user 106 and the radio broadcast. The latitude and longitude data of the computer 108 are also viewable on a computer screen by the user 106 and/or the advertiser 104. The movement of the user 106 in relation to various broadcast radio stations 102 may also be tracked. In this manner, the advertiser 104 identifies the location of the user 106 at the time of the sound capture, and learns the behavior and patterns of the user 106 for enhancing the marketing effort on the broadcast radio station 102.

in another embodiment, the system 100 enables the advertiser 104 to identify the exact location of the user 106 at the time and place that the user 106 captures a duration of the sound. This information enables the advertiser 104 to record interactive information about the user 106, such as the number of users 106 listening to the broadcast radio station, the type of requests made by the user 106, the amount of time spent listen to the radio broadcast radio station 102 by the user 106, and the overall performance of the broadcast radio station 102.

FIG. 1A illustrates the system 100 in which the user 106 may elect to view content associated with the radio broadcast, if such content is available, either by entering manually the frequency of the broadcast radio station 102, or by placing the microphone 110 at a location where the microphone 110 detects sound from the radio broadcast.

In some embodiments, when the frequency of the radio broadcast is provided directly by the user 106, the computer 108 sends the proper request to the processing unit 112. However in another embodiment, if the user 106 elects to let the computer 108 determine the frequency of the radio broadcast, the captured sound is first converted to the visual waveform 116, and the image 120 is automatically uploaded to the processing unit 112 along with other relevant data, such as the position of the computer 108, a time stamp, and the like.

Using the image related data, the processing unit 112 queries the data storage unit 122 to receive a prerecorded visual waveform 118 belonging to a targeted region. The prerecorded visual waveform 118 may include a prerecorded sound from the audio recording unit 128.

Once the frequency of the broadcast radio station 102 is known, the processing unit 112 may transmit a set of data instructing the computer 108 to connect to a specific channel of the streaming unit 130 to display the appropriate image 120, image 120 link, or image 120 data. The user 106 may then interact with that content as desired. For example, the user 106 can request for the radio broadcast program be recorded, or the user 106 may click and select to get more information about a book or other issues being discussed on the radio. Consequently, all interactive requests and submissions made be the user 106 may be recorded for providing the advertiser 104 with valuable marketing data.

In some embodiments, the user 106 can interact with the radio broadcast to request coupons, make purchases, add to favorites, and locate a URL website page. In other embodiments, the system 100 enables the user 106 to save the radio broadcast in the computer 108 or the data storage unit 122. For example, when the user 106 is performing various activities and cannot listen to the details of the radio broadcast. In this manner, the user 106 can save the radio broadcast for future listening.

In yet another embodiment, the user 106 can review and rate the broadcast radio station 102 or a product and service advertised in the radio broadcast. The ratings can help the user 106 and the advertiser 104 better understand the type of products and services offered by the broadcast radio station 102, and the optimal marketing of the products and services. For example, the feedback for the user 106 can inform the advertiser 104 about the radio broadcast and the user 106, including: how effective the radio broadcast station 102 is in converting the advertisement into a sale, the socio-economic level of the user 106, and the greatest needs requested by the user 106. In one embodiment, the review may be applied and viewed nationally and internationally. The review may include, without limitation, a numbering system, a lettering system, a star system, and a thumbs up-thumbs down system.

In one embodiment, the advertiser 104 can interact with the broadcast radio station 102 to analyze the amount of users 106 interacting with the radio broadcast, and assess the performance of specific locations for the radio broadcast station 102. The radio broadcast related information may be stored in the data storage unit 122 for subsequent queries and marketing efforts.

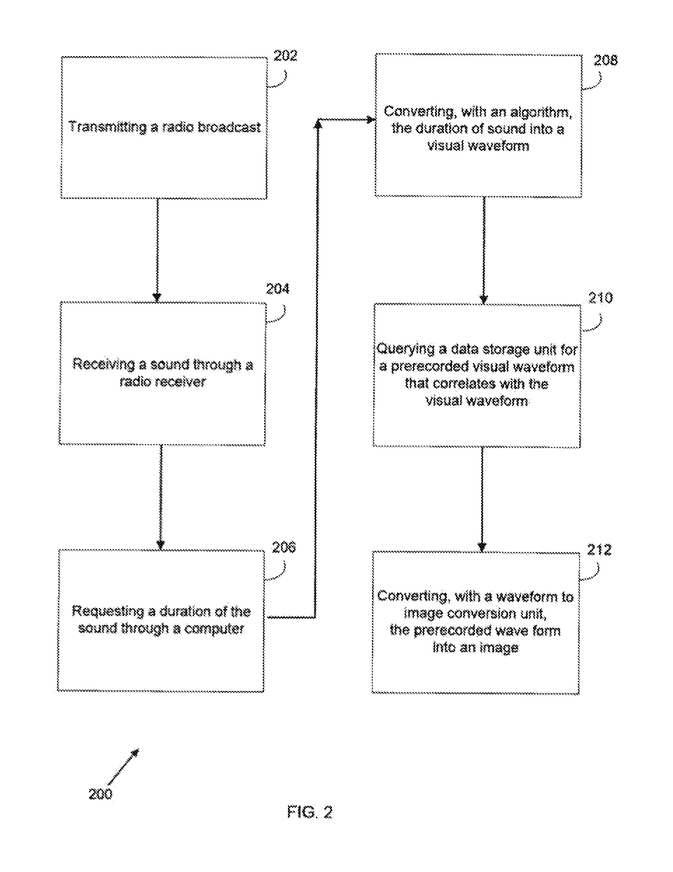

Turning now to FIG. 2, a visual radio marketing method 200 is effective for converting the sound from a radio broadcast into an image 120 while also creating an interactive relationship between a user 106, an advertiser 104, and a broadcast radio station 102. The image 120 is associated with the sound transmitted from the radio broadcast. The image 120 may be utilized by the user 106 and the advertiser 104 to enhance marketing and consumption of a product or service.

The method 200 comprises an initial Step 202 of transmitting a radio broadcast. The radio broadcast has its genesis in the broadcast radio station 102, and may include, advertisements, music, talk shows, and news. A Step 204 may include receiving a sound through a radio receiver 126. The radio waves from the broadcast radio station 102 transmit to the radio receiver 126, which may include, AM, FM, or HD.

The method 200 may further include a Step 206 of requesting a duration of the sound through a computer 108. The user 106 may control the capture of sound through a computer 108. In one embodiment, the computer 108 comprises a microphone 110 that captures the sound from the radio broadcast. The sound from the broadcast radio station 102 can be captured and stored in an audio recording unit 128 for subsequent retrieval and conversion into the image 120.

A Step 208 comprises converting, with an algorithm, the duration of the sound into a visual waveform 116. The computer 108 utilizes an algorithm to convert the captured sound into a visual waveform 116 representation. The visual waveform 116 may include a standard sine or cosine wave known in the art to represent sound wave propagation. The visual waveform 116 is representative of the image 120. A Step 210 may include querying a data storage unit 122 for a prerecorded visual waveform 118 that correlates with the visual waveform 116. The computer 108 uploads the visual waveform 116 representation into a processing unit 112.

A final Step 212 comprises converting, with a waveform to image conversion unit 114, the prerecorded visual waveform 118 into an image 120. A waveform to image conversion unit 114 converts the prerecorded visual waveform 118 into the image 120. The waveform to image conversion unit 114 utilizes a second algorithm that extracts portions of the images 120 that match a corresponding time stamp and desired length of the recording and compares them to the visual waveform 116 received from the computer 108 until a match is found. The image 120 may include a picture or a video that is associated with the captured sound from the radio broadcast.

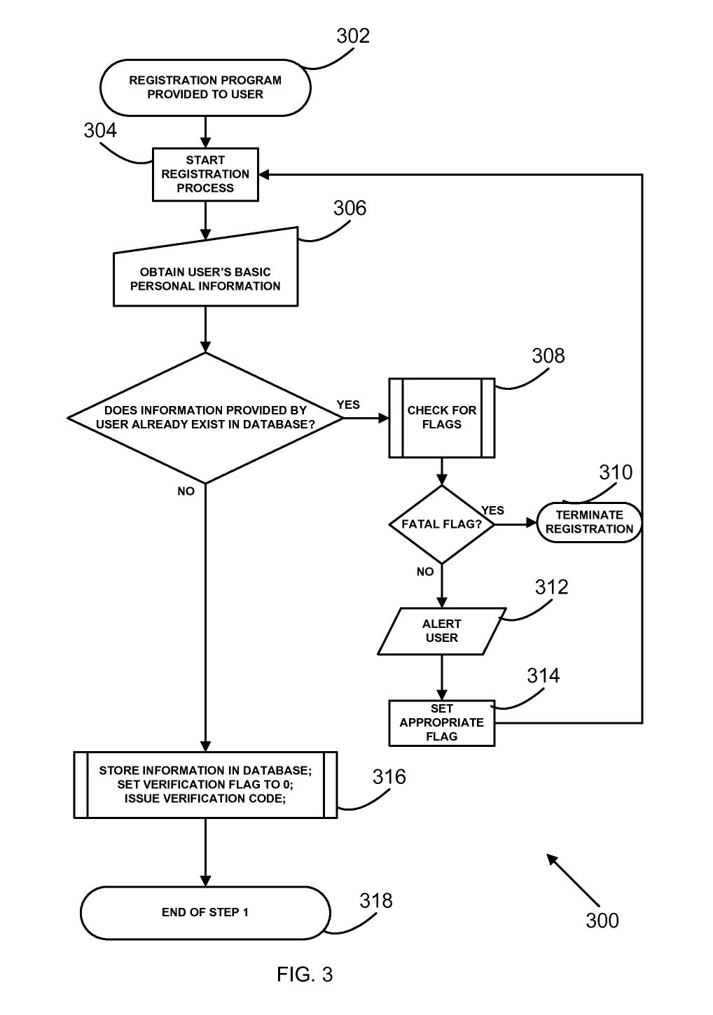

FIG. 3 is a flowchart diagrams of an exemplary method 300 for registering a new broadcast radio station. In some embodiments, the broadcast radio station 102 registers with the system 100 to broadcast to the user 106 and carry advertisement for the advertiser 104. The broadcast radio station 102 can also register to carry a specific type of product or service in the broadcast. In this manner, the system 100 can identify the optimal broadcast radio station 102 for the advertiser 106, and the integrity of the system 100 is better managed. The method 300 for registering anew broadcast radio station may include an initial Step 302 of providing the registration to the broadcast radio station 102. The registration may include forms and questionnaires for the broadcast radio station 102 to fill out. A Step 304 comprises starting the registration process. The registration process initiates through a request upon the broadcast radio station 102 deciding to partake in the system 100.

In some embodiments, a Step 306 includes obtaining the broadcast radio station 102 information. The information may include, without limitation, broadcast radio station name, address, years of doing business, and type of radio broadcast. If the broadcast radio station 102 is already registered with the system 100, a Step 308 includes checking for flags. The flags indicate issues or a problematic broadcast radio station 102. The system 100 can utilize background checks or credit checks to check for flags. If the flag is fatal, a Step 310 comprises terminating the registration. The determination of a fatal flag is determined by numerous factors, and may be subjective or objective. If the flag is not fatal, a Step 312 alerts the broadcast radio station 102. A Step 314 may then set the appropriate flag for the broadcast radio station 102. In some embodiments, if the broadcast radio station 102 is not in the system 100, the information from the broadcast radio station 102 is stored in a database in a Step 316. The verification flag can be set to a numerical value of zero, indicating a new advertiser. A verification code is then issued to the broadcast radio station 102. A Step 318 terminates the registration process, and the broadcast radio station 102 may thus participate.

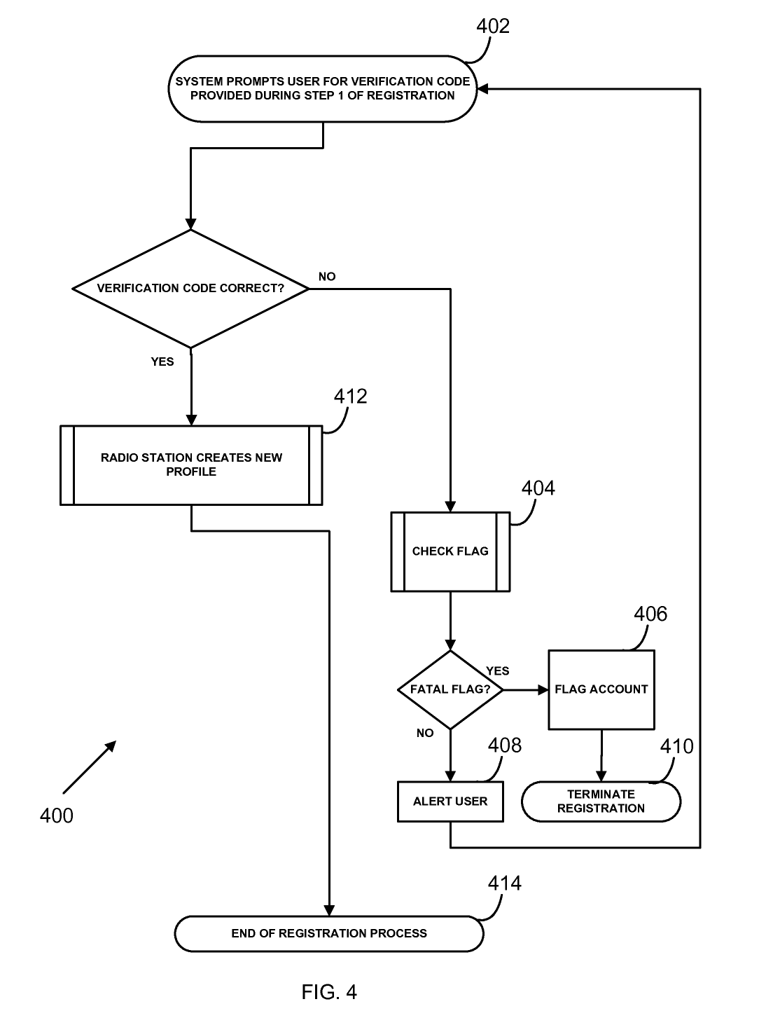

FIG. 4 is a flowchart diagrams of an exemplary method 400 for registering a new advertiser. In some embodiments, the advertiser 104 may register to participate in the system 100 for broadcasting on the radio broadcast station 102. The advertiser 104 can also register the type of product or service advertised on the radio broadcast. In this manner, the system 102 can identify the optimal radio broadcast for the advertiser 104, and the integrity of the system 100 is better managed. The method 400 for registering a new advertiser may include an initial Step 402 of the system prompting the advertiser 104 for the verification code provided in Step 316.

If the verification code is not entered correctly, a Step 404 automatically enables the system 100 to check the flag. If the flag is fatal, a Step 406 flags the account of the advertiser 104, and a Step 410 terminates the registration. However, if the flag is not fatal, a Step 408 alerts the advertiser 104, and the advertiser 104 may then return to Step 402 to be prompted for the verification code again. However, if the verification code is entered correctly, a Step 412 enables the creation of a new profile, if desired. A final Step 414 may then terminate the registration process.

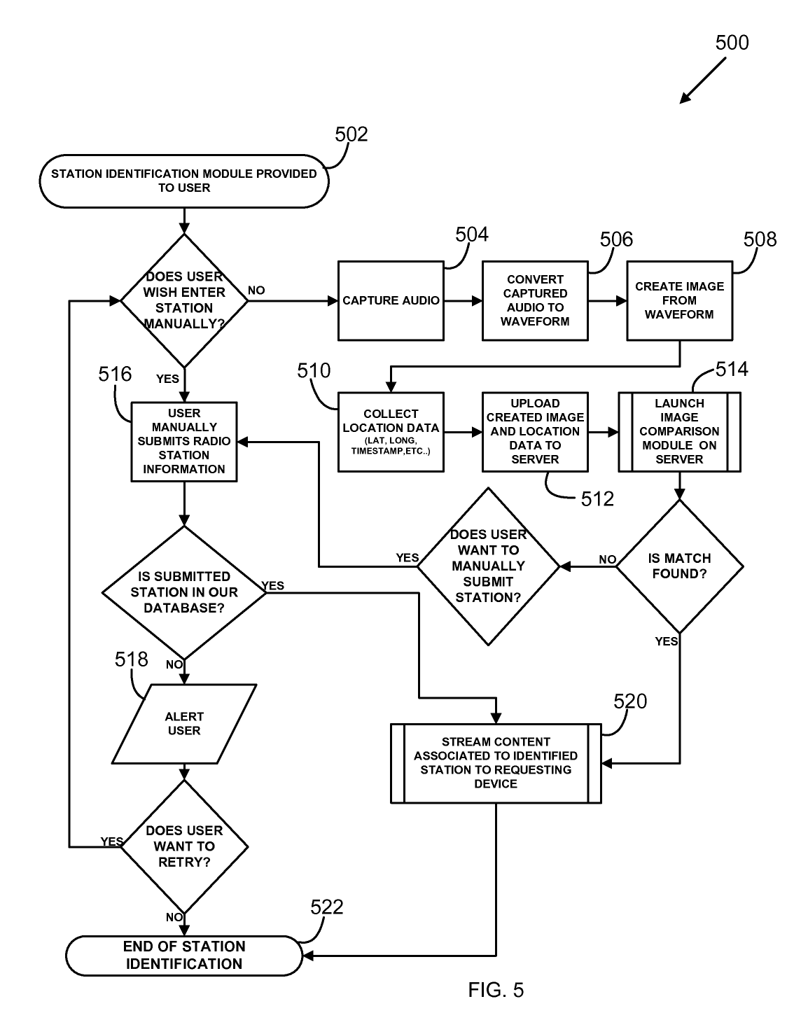

FIG. 5 is a flowchart diagram of an exemplary station identification module 500. In some embodiments, the station identification module 500 helps identify the broadcast radio station 102 through the use of the positioning system 124. The station identification module 500 may include an initial Step 502 of providing the station identification module 500 to the advertiser 104. If the advertiser 104 wishes to enter the radio broadcast station 102 manually, a Step 504 comprises capturing the sound with the microphone 110. A Step 506 then comprises converting the sound to a visual waveform 116. In some embodiments, a Step 508 may include creating an image 120 from the visual waveform 116. A step 510 comprises collecting location data through the positioning system 124. The location data may include latitude, longitude, and a time stamp for the radio broadcast station 102.

In some embodiments, the station identification module 500 may further include a Step 512 of uploading the created image and the location data to the data storage unit 122, such as a server. A Step 514 comprises launching an image comparison module on the server. If a match is found, a Step 520 includes streaming content associated to the identified radio station to request a device. From this Step 520, a Step 522 includes ending the station identification. However, if a match is not found, the advertiser 104 must decide whether to enter the broadcast radio station 102 manually again. If yes, a Step 516 comprises an advertiser 104 manually submitting the radio station information. Additionally, Step 516 is followed if the advertiser 104 initially chose to enter the radio station manually.

In some embodiments, if the submitted broadcast radio station 102 is stored in the data storage unit 122, a Step 520 of including streaming content associated to the identified radio station to request a device is performed. If the submitted broadcast radio station 102 is not stored. in the data storage unit 122, a Step 518 of alerting the advertiser 104 is performed. If the advertiser 104 wishes to retry, it must be determined again if the advertiser 104 wishes to enter the radio broadcast station 102 manually. If the advertiser 104 does not wish to retry, Step 522 of ending the station identification is performed.

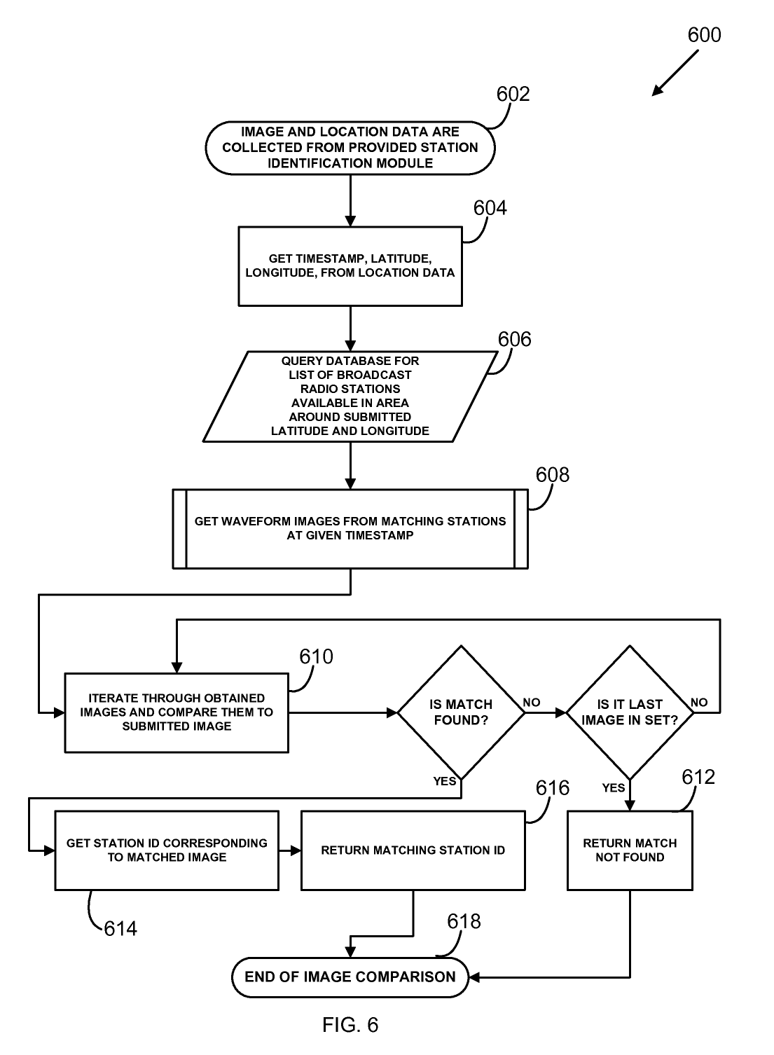

FIG. 6 is a flowchart diagram of an exemplary image comparison module 600. In some embodiments, the image comparison module 600 may be utilized to compare the visual waveform 116 with the prerecorded visual waveform 118 for generating the image 120. An initial Step 602 may include collecting the image 120 and the location data from the station identification module 500. A Step 604 comprises obtaining the latitude, longitude, and time stamp from the location data. A Step 606 may include querying the radio broadcast station available in an area proximal to the submitted latitude and longitude.

In some embodiments, a Step 608 comprises obtaining waveform images from matching stations at a given timestamp. A Step 610 may further include iterating through obtained images and comparing them to the submitted image. If a match is not found, it must be determined if it is the last image 120 in the set. If it is not the last image 120, Step 620 is repeated. If it is the last image 120, a Step 612 comprises a return match not found. A Step 618 of ending the image comparison is performed. However, if the match is not found, a Step 614 involves obtaining a broadcast radio station identification. This is followed by Step 616 of retuning a matching broadcast radio station identification. A final Step 618 of ending the image comparison is then performed.

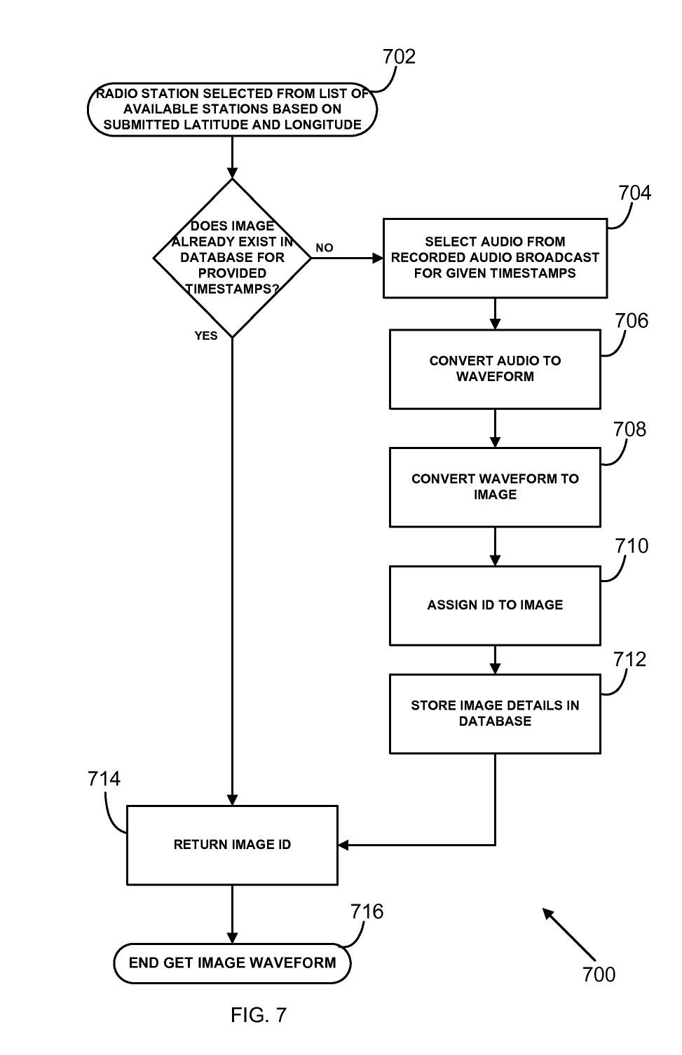

FIG. 7 is a flowchart diagrams of an exemplary method 700 for obtaining an image waveform from a radio station. In some embodiments, the method 700 for obtaining an image waveform from a radio station is effective for converting sound form the radio broadcast station 102 into an image 120. The method 700 may include an initial Step 702 of selecting a radio station from available stations based on a submitted latitude and longitude. If the image 120 exists in the data storage unit 122 for the provided time stamps, then a Step 714 of retuning an image identification is performed. The method 700 may then end on a Step 716 of ending the get image waveform.

However, if the image 120 does not exist in the data storage unit 122 for the provided time stamps, then a Step 704 of selecting audio from recorded audio broadcast for a given time stamp is performed. A Step 706 comprises converting audio to waveform. This is followed by a Step 708 of converting the waveform to an image. A Step 710 may include assigning an identification to the image. A Step 712 comprises storing the mage details in a database. The method 700 may then proceed back to Step 714 to return an image identification and subsequently Step 716 of ending the get image waveform.

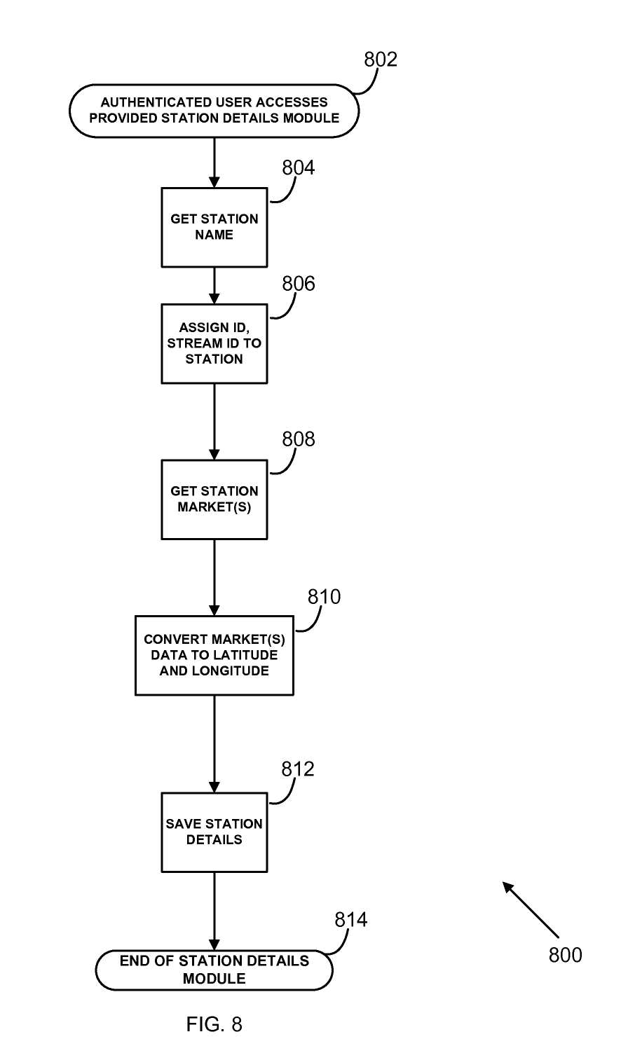

FIG. 8 is a flowchart diagram of an exemplary station details module 800. In some embodiments, the station details module 800 helps identify the radio broadcast station 102. An initial Step 802 includes an authenticated user accessing the provided stations detail module 800. A Step 804 comprises obtaining a station name. A Step 806 may include assigning an identification, and streaming the identification to a station. A Step 808 comprises obtaining a station market. A Step 810 includes converting the market data to latitude and longitude. This may be performed with the positioning system 124. A Step 812 comprises saving the station details. The station details may be saved in the data storage unit 122. A final Step 814 comprises ending the module.

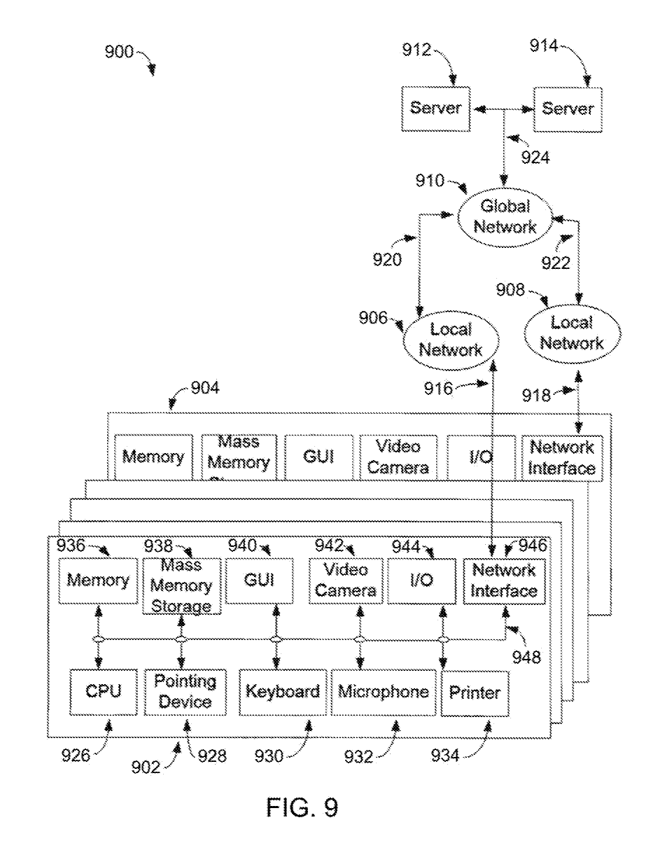

FIG. 9 is a block diagram depicting an exemplary client/server system which may be used by an exemplary web-enabled/networked embodiment of the present invention.

A communication system 900 includes a multiplicity of clients with a sampling of clients denoted as a client 902 and a client 904, a multiplicity of local networks with a sampling of networks denoted as a local network 906 and a local network 908, a global network 910 and a multiplicity of servers with a sampling of servers denoted as a server 912 and a server 914,

Client 902 may communicate bi-directionally with local network 906 via a communication channel 916. Client 904 may communicate bi-directionally with local network 908 via a communication channel 918. Local network 906 may communicate bi-directionally with global network 910 via a communication channel 920. Local network 908 may communicate bi-directionally with global network 910 via a communication channel 922. Global network 910 may communicate bi-directionally with server 912 and server 914 via a communication channel 924. Server 912 and server 914 may communicate bi-directionally with each other via communication channel 924. Furthermore, clients 902, 904, local networks 906, 908, global network 910 and servers 912, 914 may each communicate bi-directionally with each other.

In one embodiment, global network 910 may operate as the Internet. It will be understood by those skilled in the art that communication system 900 may take many different forms. Non-limiting examples of forms for communication system 900 include local area networks (LANs), wide area networks (WANs), wired telephone networks, wireless networks, or any other network supporting data communication between respective entities.

Clients 902 and 904 may take many different forms. Non-limiting examples of clients 902 and 904 include personal computers, personal digital assistants (PDAs), cellular phones and smartphones.

Client 902 includes a CPU 926, a pointing device 928, a keyboard 930, a microphone 932, a printer 934, a memory 936, amass memory storage 938, a GUI 940, a video camera 942, an input/output interface 944 and a network interface 946.

CPU 926, pointing device 928, keyboard 930, microphone 932, printer 934, memory 936, mass memory storage 938, GUI 940, video camera 942, input/output interface 944 and network interface 946 may communicate in a unidirectional manner or a bi-directional manner with each other via a communication channel 948. Communication channel 948 may be configured as a single communication channel or a multiplicity of communication channels.

CPU 926 may be comprised of a single processor or multiple processors. CPU 926 may be of various types including micro-controllers (e.g., with embedded RAM/ROM) and microprocessors such as programmable devices (e.g., RISC or SISC based, or CPLDs and FPGAs and devices not capable of being programmed such as gate array ASICs (Application Specific Integrated Circuits or general purpose microprocessors.

As is well known in the art, memory 936 is used typically to transfer data and instructions to CPU 926 in a bi-directional manner. Memory 936, as discussed previously, may include any suitable computer-readable media, intended for data storage, such as those described above excluding any wired or wireless transmissions unless specifically noted. Mass memory storage 938 may also be coupled bi-directionally to CPU 926 and provides additional data storage capacity and may include any of the computer-readable media described above. Mass memory storage 938 may be used to store programs, data and the like and is typically a secondary storage medium such as a hard disk. It will be appreciated that the information retained within mass memory storage 938, may, in appropriate cases, be incorporated in standard fashion as part of memory 936 as virtual memory.

CPU 926 may be coupled to GUI 940, GUI 940 enables a user to view the operation of computer operating system and software. CPU 926 may be coupled to pointing device 928. Non-limiting examples of pointing device 928 include computer mouse, trackball and touchpad. Pointing device 928 enables a user with the capability to maneuver a computer cursor about the viewing area of GUI 940 and select areas or features in the viewing area of GUI 940. CPU 926 may be coupled to keyboard 930. Keyboard 930 enables a user with the capability to input alphanumeric textual information to CPU 926, CPU 926 may be coupled to microphone 932. Microphone 932 enables audio produced by a user to be recorded, processed and communicated by CPU 926. CPU 926 may be connected to printer 934, Printer 934 enables a user with the capability to print information to a sheet of paper. CPU 926 may be connected to video camera 942. Video camera 942 enables video produced or captured by user to be recorded, processed and communicated by CPU 926.

CPU 926 may also be coupled to input/output interface 944 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 926 optionally may be coupled to network interface 946 which enables communication with an external device such as a database or a computer telecommunications or internet network using an external connection shown generally as communication channel 916, which may be implemented as a hardwired or wireless communications link using suitable conventional technologies. With such a connection, CPU 926 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the visual radio marketing system could be configured to receive coded signals and convert the codes into images, rather than the sound of a radio broadcast. Accordingly, the scope should be determined not by the embodiments illustrated, but by the appended claims and their legal equivalents.

What is claimed is:

1. A visual radio marketing system for converting a sound from a radio broadcast into an image for creating interactivity to the broadcast radio, the visual radio marketing system comprising:
a radio receiver configured to receive a sound from a broadcast radio station;
a computer comprising a microphone configured to capture a duration of the sound, the computer further comprising an algorithm, the algorithm configured to convert the duration of the sound into a visual waveform;
a processing unit configured to query a data storage unit for a prerecorded visual waveform, the prerecorded visual waveform configured to correlate to the visual waveform; and
a waveform to image conversion unit configured to convert the prerecorded visual waveform to an image,
wherein the image enables interactivity between a user and an advertiser with a radio broadcast.

2. The system of claim 1, in which the broadcast radio station is configured to transmit a live radio broadcast.

3. The system of claim 2, in which the radio receiver comprises an AM and/or an FM and/or a high definition radio receiver.

4. The system of claim 3, in which the computer comprises a laptop.

5. The system of claim 4, in which the comprises a voice.

6. The system of claim 5, in which the duration of the sound comprises a few seconds of sound.

7. The system of claim 6, in which the computer is configured to upload datum to the processing unit, the datum comprising the image, an image capture time, a location of the computer at the time of the sound capture.

8. The system of claim 7, in which the computer is configured to process the sound, process user input data, and display the image.

9. The system of claim 8, in which the computer comprises a positioning system configured to identify the location of the computer and the time of sound capture for enhancing marketing for the advertiser.

10. The system of claim 9, in which the positioning system comprises a global positioning system, the global positioning system configured to generate a latitude and longitude data of the computer.

11. The system of claim 10, in which the data storage unit comprises a server.

12. The system of claim 11, in which the data storage unit is configured to store at least one image, and/or a link to the image, and/or an advertisement displayed at the computer, and/or an expiration time for the advertisement, and/or a preference of the user.

13. The system of claim 12, in which the data storage unit is configured to return a dataset to the processing unit when queried by the processing unit.

14. The system of claim 13, in which the dataset comprises the image, and/or a link to the image, and/or an advertisement displayed at the computer, and/or an expiration time for the advertisement, and/or a preference of the user.

15. The system of claim 14, in which the image comprises a time stamp and a radio broadcast station information, the time stamp and the radio broadcast station information configured to store in the data storage unit.

16. The system of claim 15, in which the computer operatively joins with a streaming unit, the streaming unit configured to stream the image and/or data to the computer for display.

17. The system of claim 16, in which the system comprises an audio recording unit configured to record and store the duration of the sound.

18. The system of claim 17, in which the system is configured to enhance marketing by enabling the user to review the radio broadcast, and/or providing a coupon to the user, and/or identifying an address and a distance to the advertiser relative to the user.

19. One or more computer storage media storing computer-usable instructions, that when used by one or more computing devices, cause the one or more computing devices to perform a method for marketing a billboard, the method comprising the steps of:
(a) transmitting a radio broadcast;
(b) receiving a sound through a radio receiver;
(c) requesting a duration of the sound through a computer;
(d) converting, with an algorithm, the duration of sound into a visual waveform;
(e) querying a data storage unit for a prerecorded visual waveform that correlates with the visual waveform; and
(f) converting, with a waveform to image conversion unit, the prerecorded waveform into an image.

20. A non-transitory program storage device readable by a machine tangibly embodying a program of instructions executable by the machine to perform a method for marketing a billboard, the storage device comprising:
a) computer code for transmitting a radio broadcast;
b) computer code for receiving a sound through a radio receiver;
c) computer code for requesting a duration of the sound through a computer;
d) computer code for converting, with an algorithm, the duration of sound into a visual waveform;
e) computer code for querying a data storage unit for a prerecorded visual waveform that correlates with the visual waveform; and
f) computer code for converting, with a waveform to image conversion unit, the prerecorded waveform into an image.
